(19) United States
(12) Patent Application Publication
(10) Pub. No.: US 2006/0165263 A1
(43) Pub. Date: Jul. 27, 2006

(54) Person verification apparatus, information processing apparatus and person verification system

(75) Inventor: Tetsuya Niitsuma, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/234,766

(22) Filed: Sep. 23, 2005

(30) Foreign Application Priority Data
Jan. 24, 2005 (JP) JP2005-015667

(51) Int. Cl. G06K 9/00

(52) U.S. Cl. 382/115; 340/5.52

(57) ABSTRACT

A person verification apparatus, having a biological information input section to receive an input of biological information of a user and obtain data to be verified; and a first control section to obtain previously registered reference data corresponding to information to identify a type of the biological information input section, and to perform a first person verification process for determining success or failure of a user verification by comparing the obtained reference data with the data to be verified.

### CROSS REFERENCE TO RELATED APPLICATION

The present application is based on Japanese Patent Application No. 2005-015667 filed with Japan Patent Office on Jan. 24, 2005.

### BACKGROUND OF THE INVENTION

1. Field of the Invention

The present invention relates to a person verification apparatus, information processing apparatus and a person verification system.

2. Description of Related Art

In the prior art, in order to ensure security, an IC (Integrated Circuit) card, or the combination of user ID and password have been inputted, and such inputted information has been used to carry out person verification. In particular, person verification is carried out based on comparison of a fingerprint wherein the fingerprint is used to provide biological information. It has also been suggested that image forming apparatuses such as copy machines have person verification function therein.

In fingerprint verification, the fingerprint inputted by a user through a fingerprint sensor is scanned or read to get the image data. From this image data, the data to be verified (hereinafter may be referred to as “interrogee data”) showing the feature of the fingerprint is obtained. The interrogee data having been inputted is compared with the registered reference data for a plurality of persons registered in advance. Then the success or failure person verification is determined according to the result of the comparison. Here a module composed of a fingerprint image data acquisition section and a interrogee data extraction section is called the fingerprint verification module. The fingerprint verification module may be provided with a verifying unit against the interrogee data.

However, since a fingerprint sensor and a system equipped with the fingerprint sensor are updated, there are differences in the format such as resolution and size of the image data obtained from the scanned fingerprint, and differences in the method of verification and version number. This makes it difficult to achieve compatibility in the format between the inputted data to be verified and registered reference data.

To solve this problem, the following arrangement has been proposed in which when there is a difference in the image data format, the format of the image data of the fingerprint having been inputted is changed to conform to the registered reference data. The data to be verified is obtained from this changed image data. According to another arrangement having been proposed, when there is a difference in the version of the verification method, the registered reference data is reconfigured to conform to the method of verification for the inputted data to be verified. According to a further proposal, the version number of the verification method is attached to the data to be verified. Further, in Japanese Unexamined Laid-Open Patent Publication No. 2001-84371, at the time of verification, reference is made to the attached version number of the verification method. Verification is carried out when the inputted data to be verified and the registered reference data are based on one and the same method of verification.

The data to be verified is expressed in terms of the feature point representing the features of the fingerprint image data, and various formats such as frequency component of the image data. It cannot be easily converted according to the prior art fingerprint image data format and registered reference data conversion arrangement. Further, verification precision may deteriorate, or verification may not be achieved, according to this prior art.

Further, in the prior art arrangement of attaching the verification format version number to the data to be verified, compatibility between the data to be verified and registered reference data may not be achieved, if there is a change in the data to be verified inputting format or the method of extracting the data to be verified from the finger image data, although one and the same verification format is utilized.

### SUMMARY OF THE INVENTION

The object of the present invention is to ensure person verification to be made without deterioration of verification precision, despite the presence of different verification modules in a mixed form.

(1) TO achieve the above mentioned object, a person verification apparatus according to one typical embodiment reflecting a first aspect of the present invention, comprises:

a biological information input section to receive an input of biological information of a user and obtain data to be verified; and

a first control section to obtain previously registered reference data corresponding to information to identify a type of the biological information input section and to perform a first person verification process for determining success or failure of a user verification by comparing the obtained reference data and the data to be verified.

(2) According to another typical embodiment reflecting a second aspect of the present invention, an information processing apparatus connected to be capable of mutual communication with a person verification apparatus having a biological information input section to receive an input of biological information of a user and obtain data to be verified, comprises a second control section performing, when information to identify a type of the biological information input section is inputted from the person verification apparatus, a first reference data providing process for searching a piece of reference data corresponding to the information to identify a type of the biological information input-section, and for outputting a result of the searching.

### BRIEF DESCRIPTION OF THE DRAWINGS

The above mentioned and other objects, advantages and features of the invention will become apparent from the following description thereof taken in conjunction with the accompanying drawings in which:

FIG. 1 is a block diagram representing the configuration of the MFP system 1 as a first embodiment of the present invention;

FIG. 2 is a block diagram representing the internal configuration of the MFP 2A;

FIG. 3 is a block diagram representing the internal configuration of the server 40;

FIG. 4 (a) is a diagram representing a module type information 100; FIG. 4 (b) a diagram representing the configuration of the first registered referential database DB 200; FIG. 4 (c) a diagram representing the configuration of the second registered referential database DB 300; and FIG. 4 (d) a diagram representing the configuration of the module type information database DB 400;

FIG. 5 is a flowchart representing the first person verification process;

FIG. 6 is a flowchart representing the first referential data providing process;

FIG. 7 is a flowchart representing the second referential data providing process;

FIG. 8 is a diagram representing the flow of data in the person verification process and others;

FIG. 9 is a block diagram representing the configuration of the MFP system 1A as a present embodiment;

FIG. 10 is a diagram representing the configuration of the third referential database DB 500;

FIG. 11 is a flowchart representing the second person verification process;

FIG. 12 is a flowchart representing the verification result providing process;

FIG. 13 is a diagram representing the flow of the second person verification process and others;

FIG. 14 is a block diagram representing the configuration of the MFP system 1B as the present embodiment; and

FIG. 15 is a flowchart representing the module identification process.

### DETAILED DESCRIPTION OF THE PREFERRED EMBODIMENT

The above-mentioned object of the invention can be achieved further by the following embodiments.

Referring to the drawings, the following describes the first, second and third embodiments of the present invention, without the prevent invention being restricted to the illustrated examples.

### Embodiment 1

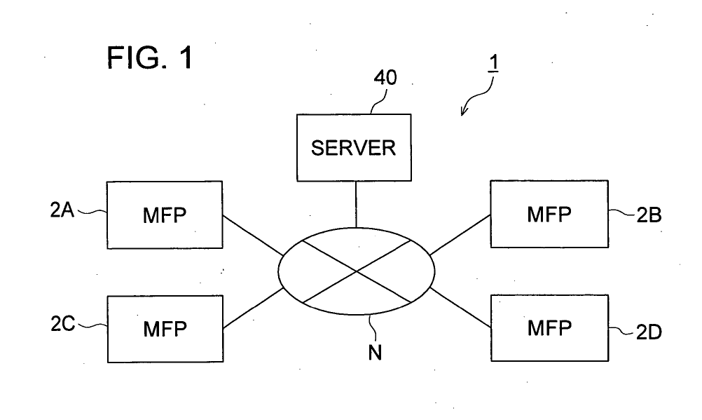

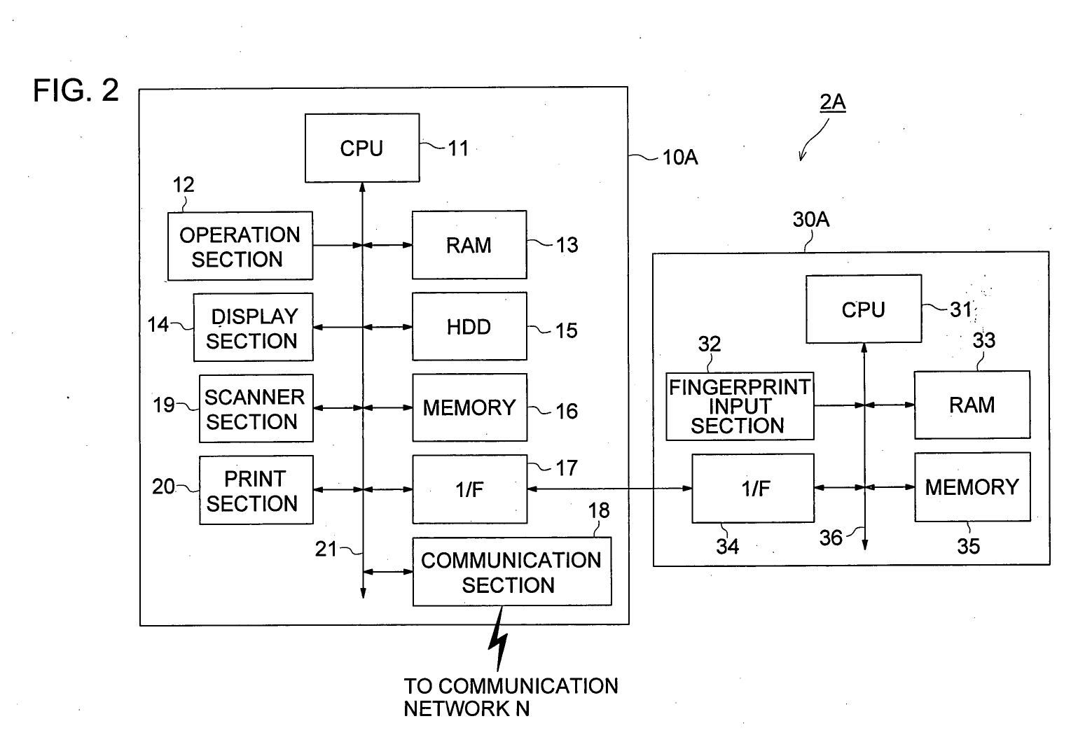

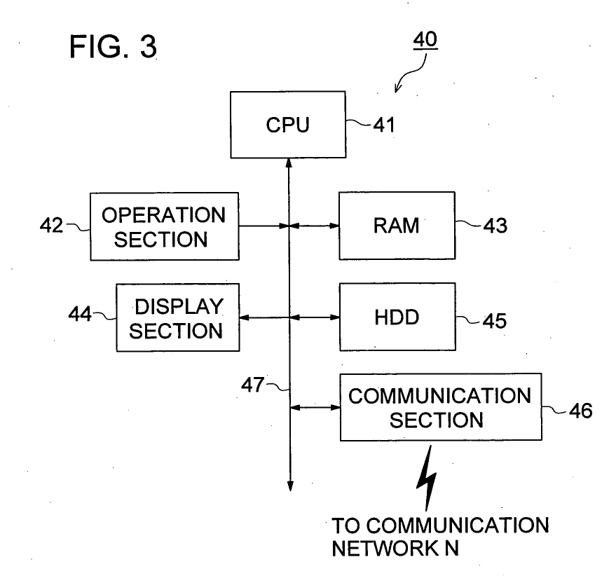

The following describes the first embodiment of the present invention with reference to FIGS. 1 through 8. In the first place, FIGS. 1 through 3 will be used to describe the features of an apparatus as the present embodiment. FIG. 1 shows the configuration of an MFP system 1. FIG. 2 shows the internal configuration of a MFP 2A. FIG. 3 represents the internal configuration of a server 40.

An MFP (Multi-Function Peripheral) as the person verification system of the present embodiment will be described with reference to FIG. 1. The MFP system 1 comprises the MFPs 2A, 2B, 2C and 2D as person verification apparatuses and the server 40 as an information processing apparatus. These devices are connected via the communication network N so as to permit mutual communication.

The communication network N is a LAN (Local Area Network), for example. But it can be a WAN (Wide Area Network), a telephone line network, an ISDN (Integrated Service Digital Network) line network, a wide-area communication line network, a leased line, a mobile communication network, a communications satellite line, a CATV (community antenna television) line, an optical communication line, a radio communication line or an internet service provider for connecting the aforementioned lines.

The MFP 2A will be used for the following discussion as a representative of the MFPs. As shown in FIG. 2, the MFP 2A is provided with:

an MFP main body 10A having both the scanning and printing functions; and

a fingerprint verification module 30A for person verification, wherein the aforementioned fingerprint verification module 30A as a single body is equipped with a user's fingerprint input function, a function of extracting data to be verified from the inputted fingerprint image data and a function of verification with the extracted data to be verified.

In the MFP 2A, the fingerprint verification module 30A can be replaced by that of a different module type. One type of the fingerprint verification module can be replaced by another type, depending on the difference in the purpose of usage, for example, cost-based, security-based or other usage.

For the following description, the types of the fingerprint verification module contained in each of the MFPs 2A, 2B, 2C and 2D are assumed as follows: One type is used for MFPs 2C and 2D, and another type for MFPs 2A and 2B. Different module types will be used for the MFPs 2A and 2C.

In the following description of the present embodiment, the MFP system 1 has four MFPs, without the present invention being restricted to this number. Further, the number of the types of the fingerprint verification modules in the MFP system 1 and a combination of the MFPs having the same fingerprint verification module are not restricted to the above description. The information processing apparatus is not restricted to the server alone, and a PC (personal computer), MFP and other image forming apparatuses can be used.

The MFP 2A is provided with a CPU (Central Processing Unit) 11, operation section 12, RAM (Random Access Memory) 13, display section 14, HDD (Hard Disk Drive) 15, memory 16, interface 17, communication section 18, scanner section 19 and printing section 20. These sections are connected by the bus 21.

The CPU 11 provides central control of various sections in the MFP main body 10A. Under the control of the CPU 11, the system program stored in the HDD 15 or memory 16 and the application program specified from various ones are displayed on the RAM 13. Various forms of processing are implemented through collaboration with the programs displayed on the RAM 13.

The operation section 12 receives such information as the user ID inputted by the user operation as an inputted signal, and outputs the inputted signal to the CPU 11.

The RAM 13 provides a work area for storing the program, input data and the result of processing. Information is temporarily stored in the RAM 13.

The display section 14 is composed of an LCD (liquid crystal display) and others. It displays various forms of information in response to the display signal from the CPU 11. Particularly it displays various types of operation screens. The display section 14 can be integrated with the operation section 12 to form a touch panel.

The HDD 15 stores various forms of data such as image data and various blocks so that they can be read and written. The HDD 15 stores the first person verification program for first person verification process to be described later, and the second reference data providing program for the second reference data providing process.

The memory 16 includes the image memory for storing the data used in the MFP main body 10A and the local memory. It comprises such a memory as a flash memory for storing data so that it can be read and written, and a ROM (Read Only Memory) for storing the data that need not be rewritten.

The interface 17 is connected with an external module through a communication cable to permit communication. It exchanges various forms of data with the connected external module. In the present embodiment, it is connected with the fingerprint verification module 30A for communication.

The scanner section 18 is composed of an NIC (Network Interface Card) and is used to exchange various forms of data with such an external apparatus as server 40 via the communication network N.

The scanner section 19 scans the image recorded on the document and generates the image data thereof. The scanner section 19 comprises a light source for applying light to a document; a CCD (charge coupled device) for photoelectric conversion of the light reflected from the document; an image sensor such as a CMOS (complementary metal oxide semiconductor); scanning unit for scanning light applied to the document; and an image processing section for outputting image data by applying various forms of conversion and processing to the electrical signal read by the image sensor.

The printing section 20 is an inkjet printer, laser printer, a thermal transfer printer or a dot impact printer. An image is formed and recorded on a recording medium such a recording paper, according to the image data inputted from the CPU 11.

The fingerprint verification module 30A comprises a CPU 31, a fingerprint input section 32, a RAM 33, an interface 34 and a memory 35. These sections are connected by a bus 36.

The CPU 31, RAM 33, interface 34 and memory 35 performs the same functions as CPU 11, RAM 13, interface 17 and memory 16, respectively. The CPU 31 provides central control of various sections in the fingerprint verification module 30A. The interface 34 is used for communication with the MFP main body 10A. The memory 35 stores various forms of data so that they can be read and written. In particular, it is the first memory section for storing the module type information 100 for identifying the type of the fingerprint input section 32, and the first reference database DB 200.

The fingerprint input section 32 reads the fingerprint (such as forefinger print) of a user as a fingerprint image, generates and acquires the data to be verified representing the features of the fingerprint image data, and outputs it to the CPU 11. The data to be verified is composed of the data representing the feature points of the fingerprint image and others, and is used to identify a fingerprint. In the present embodiment, the fingerprint is scanned with a finger placed on a specified position. It is also possible to use a sweep type structure where the fingerprint is read while the finger is slid.

The server 40 comprises a CPU 41, an operation section 42, a RAM 43, a display section 44, HDD 45 and a communication section 46. Each section is connected by a bus 47. The CPU 41 and RAM 43 have the same function as the CPU 11 and RAM 13, respectively. The operation section 42 is provided with a key input device such as a keyboard and may contain a pointing device such as a mouse. The display section 44 provides a display means such as a CRT (cathode ray tube) or LCD.

The communication section 46 is composed of the NIC and others, and exchanges various forms of data with such external apparatuses as MFPs 2A, 2B, 2C and 2D via the communication network N.

The HDD 45 is the same as the HDD 15. It stores a first reference data providing program for reference data providing process, a second registered reference database DB 300, and a module type information database DB 400.

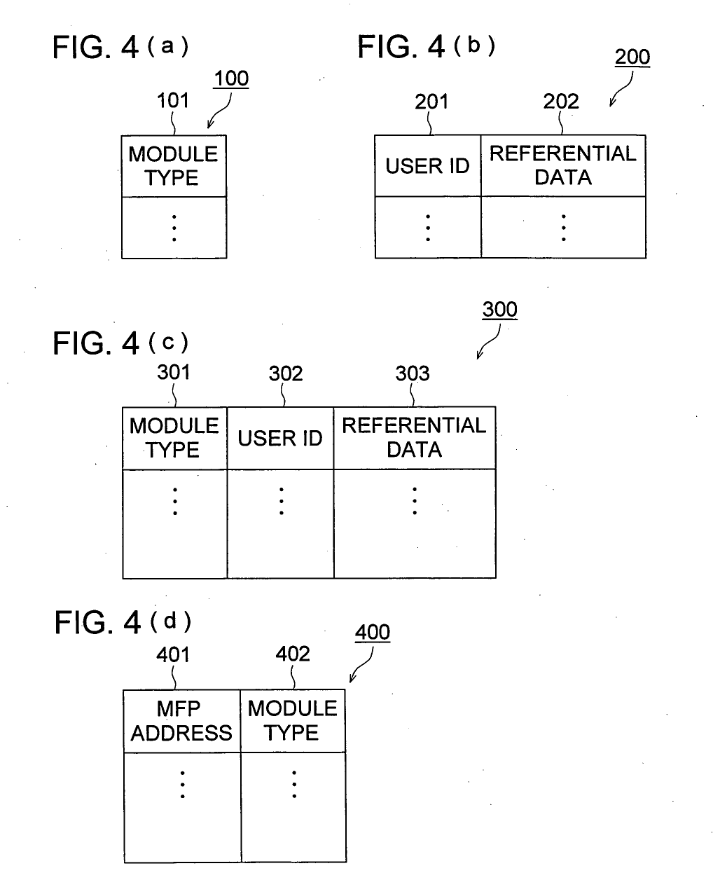

The following describes the data stored in the MFP 2A and server 40 with reference to FIG. 4. FIG. 4 (a) shows module type information 100. FIG. 4 (b) represents the configuration of the first registered reference database DB 200. FIG. 4 (c) indicates the configuration of the second registered reference database DB 300. FIG. 4 (d) shows the configuration of the module type information database DB 400.

The memory 35 of the fingerprint verification module 30A of the MFP 2A stores the module type information 100 shown in FIG. 4 (a) and the first reference database DB 200 shown in FIG. 4 (b).

The module type information 100 contains the module type 101 for identifying the type of the preset fingerprint verification module. The module type 101 includes information on the fingerprint verification module finger input (image reading) method, the data to be verified extraction method from the fingerprint image data, and the verification method of the data to be verified.

The first registered reference database DB 200 contains such items as a user ID 201 identifying a plurality of users registered in advance, and the reference data 202 registered in the form associated with the user ID 201.

The module type information 100 can be stored in the HDD 15 and memory 16. Similarly, the module type information 100 and first reference database DB 200 are stored in each of the MFPs 2A, 2B and 2C.

The second reference database DB 300 shown in FIG. 4 (c) and the module type information database DB 400 shown in FIG. 4 (d) are stored in the HDD 45 of the server 40.

The second reference database DB 300 contains such items as the fingerprint verification module type 301 from which the registered reference data 303 is obtained, and the user ID 302 corresponding to the module type 301 and the reference data 303 corresponding to the user ID 302.

The reference database DB 400 contains such items as a communication address 401 as information for identification of MFPs 2A, 2B, 2C and 2D, and a module type 402 corresponding to the MFP of the communication address 401.

In the present embodiment, the module types of the MFPs 2A and 2B are the same, and those of MFPs 2C and 2D are the same. Further, in the initial phase after system introduction, no record is assumed to be contained in the first and second registered reference databases DB 200 and 300. The record of the first reference database DB 200 is registered in the MFPs 2A, 2B, 2C and 2D. To put it more specifically, the user ID is inputted into he MFPs 2A, 2B, 2C and 2D through the operation section 12 of the MFP main body. The fingerprint of the user is inputted through the fingerprint input section 32 in the fingerprint verification module, and the image data thereof is obtained. The reference data is extracted from this image data, and the inputted user ID and reference data is stored and registered in the user ID 201 of the first reference database DB 200 and the reference data 202 as records.

The first and second registered reference database DB 200 and 300 store the data for verification (reference data) representing the feature of the image data; the image data obtained by reading the fingerprint is not stored therein. This is because a security problem may arise if the fingerprint image data is stored. Similarly, to enhance security, reference data 202 and 303 of the first and second reference database DB 200 and 300 are encrypted before being stored.

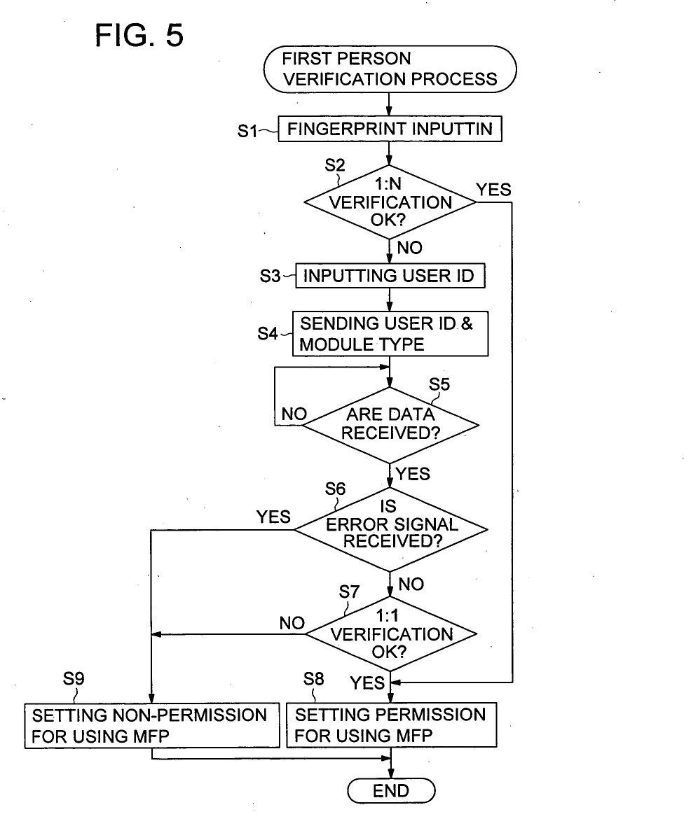

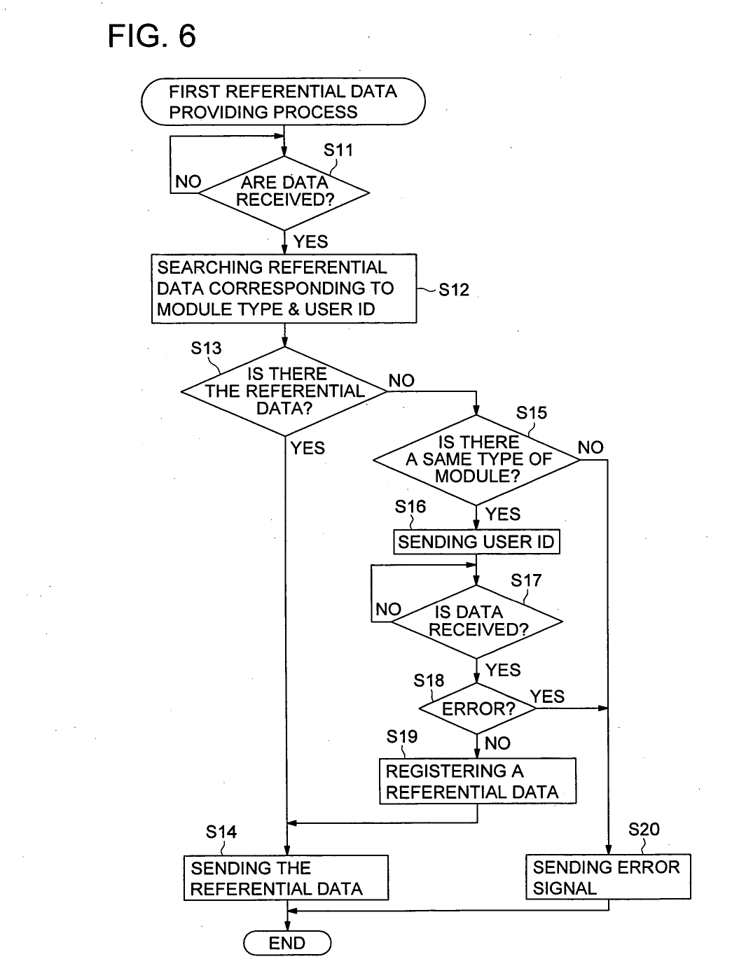

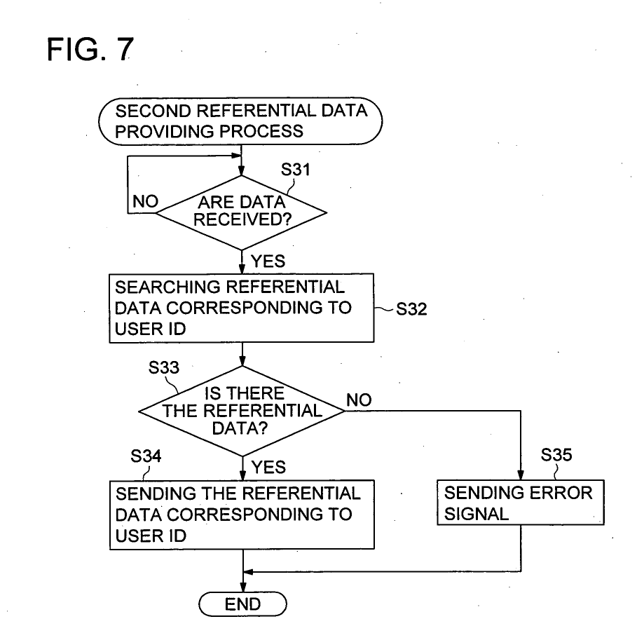

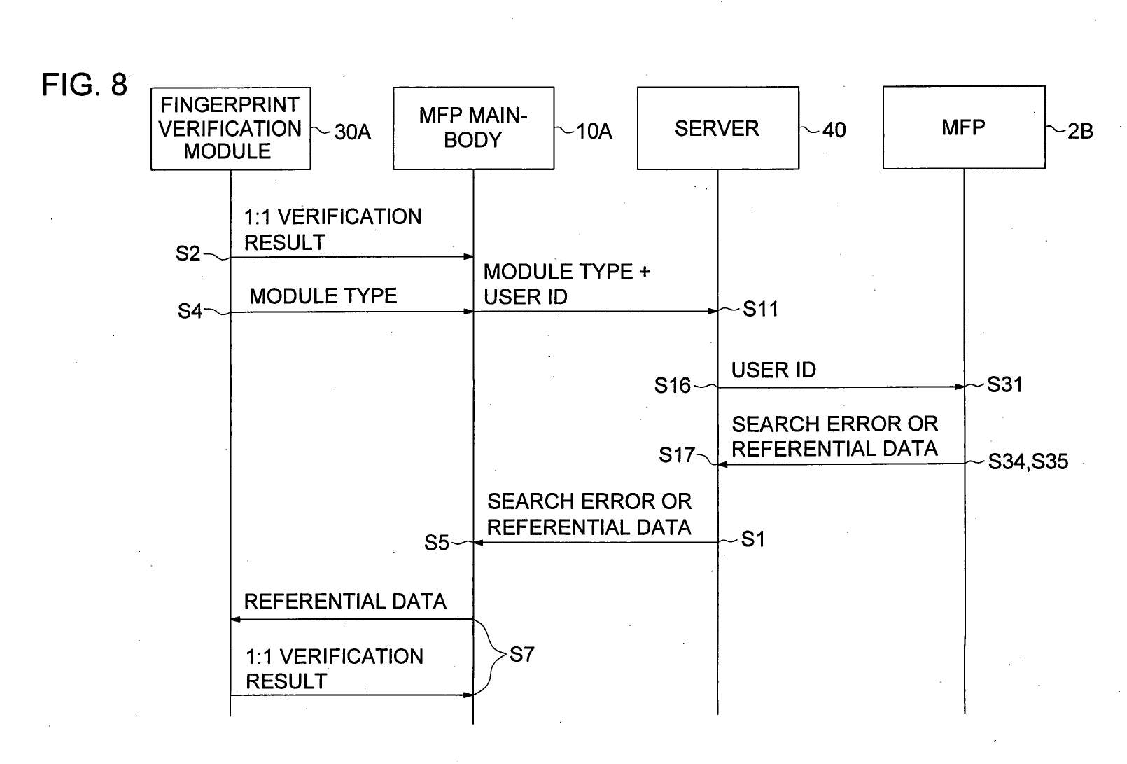

Referring to FIGS. 5 through 8, the following describes the operation of the MFP system 1. FIG. 5 indicates the flow of the first person verification process. FIG. 6 shows the flow of the first reference data providing process. FIG. 7 gives the flow of the second reference data providing process. FIG. 8 represents the flow of data in the person verification process and others.

In the present embodiment, the first person verification process shown in FIG. 5 is implemented by the MFP 2A. The second reference data providing process shown in FIG. 7 will be explained using an example implemented by the MFP 2B as the same verification module as the MFP 2A. The description is the same for other MPFs. The first reference data providing process shown in FIG. 6 is performed by the server 40.

Referring to FIGS. 5 through 8, the following describes the first person verification process carried out by the MFP 2A. For example, immediately after first person verification process execution instruction has been inputted from the operation section 12, the first person verification program is read from the HDD 15 and is displayed on the RAM 13. The first person verification process is implemented through collaboration with the CPU 11 and the first person verification program displayed on the RAM 13.

In the fingerprint verification module 30A, the fingerprint of the user is inputted through the fingerprint input section 32, and the image data thereof is obtained. The data to be verified showing the fingerprint features is extracted from this image data (Step S1). Inputting of this fingerprint and data to be verified extraction are performed according to the input/extraction method that depends on the module type of the fingerprint verification module 30A.

The first registered reference database DB 200 stored in the memory 35 is read and is decoded, and comparison is made according to predetermined criteria for verification between the data to be verified of the fingerprint inputted in Step S1 and each piece of the reference data 202 of the first reference database DB 200. Success or failure of user verification is determined according to whether matched reference data is found in the first reference database(Step S2). As described above, the verification method by comparison between one piece of data to be verified and N pieces of registered reference data (where N indicates any number in the plural) is called a 1:N verification method. Verification of the data to be verified in the Step S2 is carried out according to the method depending on the module type of the fingerprint verification module 30A. The result of the 1:N verification is sent to the MFP main body 10A through the interface 34.

Verification of the data to be verified with the reference data is made by comparing whether or not matching is found in feature points or the like in each piece of data. There is almost no complete matching. If the rate of similarity between the reference data is equal to or greater than a predetermined threshold value, verification is assumed as successful. If the rate of similarity smaller than a predetermined threshold value, verification is assumed to have failed.

If verification has failed in the 1:N verification (NO in Step S2), a user ID is inputted by the user having inputted the fingerprint through the operation section 12 in the MFP main body 10A (Step S3). Then the module type 101 of the module type information 100 stored in the memory 35 is read out and the module type is sent to the MFP main body 10A through the interface 34 from the fingerprint verification module 30A. In the MFP main body 10A, the module type and the user ID inputted in step S3 are sent to the server 40 via the communication section 18 and communication network N (Step S4). The data having been sent to the server 40 in Step S4 includes the message that the module type and reference data corresponding to the user ID are requested.

A decision step is taken to determine if the data (data for search error or reference data corresponding to the user ID) has been received from the server 40 via the communication network N or communication network N (Step S5). If the data is not received (NO in Step S5), the system goes to Step S5.

When the data has been received (YES in Step S5), a decision step is taken to determine if the received data is the error data (search error for the reference data) or not (Step S6). If the received data is not the error data (NO in Step S6), the received data is the reference data corresponding to the ID of the user having been inputted the fingerprint. The reference data corresponding to that user ID is sent to the fingerprint verification module 30A through the interface 17. In the fingerprint verification module 30A, the data to be verified for the fingerprint inputted in Step S1 is compared with the reference data corresponding to the user ID having been received. The success or failure of verification is determined, depending on whether matching is found in the reference data (Step S7). As described above, one piece of data to be verified is compared with one piece of reference data for verification. This is called the 1:1 verification method. The result of verification by this 1:1 verification method is sent to the MFP main body 10A from the fingerprint verification module 30A through the interface 34.

When the 1:N verification has been successful (YES in Step S2), or the 1:1 verification has been successful (YES in Step S7), permission to use the MFP 2A is granted to the user having inputted the fingerprint (Step S8), since the fingerprint verification has been successful in the MFP main body 10A. Then the first person verification process terminates. This arrangement enables the MFP 2A for use by the user having been inputted the fingerprint.

If the received data is the error data (YES in Step S6), or the 1:1 verification has failed (NO in Step S7), the non-permission to use the MFP 2A by the user having been inputted the fingerprint is set (Step S9), and the first person verification process terminates. This arrangement disables the MFP 2A for use by the user having been inputted the fingerprint.

Referring to FIGS. 6 and 8, the following describes the first reference data providing process implemented by the server 40, in response to the first person verification process. For example, immediately when the first reference data providing process execution instruction is inputted from the communication section 46, the first reference data providing program is read from the HDD 45 and is displayed on the RAM 43. The first reference data providing process is performed through collaboration between the CPU 41 and the first reference data providing program.

A decision step is taken to determine if the module type and user ID have been received or not from the MFP 2A (MFP main body 10A) through the communication section 46 and communication network N (Step S11), in response to the Step S4. If the module type and user ID have not been received from the MFP 2A (NO in Step S11), the system goes to the Step S11. When the module type and user ID has been received (YES in Step S11), the reference data corresponding to the received module type and user ID are searched from the second reference database DB 300 stored in the HDD 45 (Step S12). A decision step is taken to determine if the reference data 303 corresponding to the module type and user ID is present or not (Step S13).

When the reference data 303 corresponding to the module type and user ID is present (YES in Step S13), the reference data corresponding to the module type and user ID is sent to the MFP 2A through the communication section 46 and communication network N, in response to the Step S5. The first reference data providing process then terminates.

When the reference data 303 corresponding to the module type and user ID is not present (NO in Step S13), reference is made to the module type information database DB 400 stored in the HDD 45, and a decision step is taken to determine whether or not there is (the MFP address 401 of) the same module type 402 as the received module type (Step S15). If there is the same module type 402 (YES in Step S15), the MFP address 401 of the same module type 402 is obtained and the received ID is sent to the MFP of the MFP address of the same module type through the communication section 46 and communication network N (Step S16). The following describes what is sent to the MFP address of the MFP 2B of the same module type:

A decision step is taken to determine whether or not the data (error data or the reference data corresponding to the user ID) has been received from the MFP 2B through the communication network N and communication section 46 (Step S17). If the data has not yet received (NO in Step S17), the system goes to Step S17. If the data has been received (YES in Step S17), a decision step is taken to determine whether or not the received data is the reference data search error data (Step S18). If the received data is not the error data (NO in Step S18), the received data is the reference data corresponding to the user ID of the user having inputted the fingerprint and the reference data is not registered in the second reference database DB 300 stored in the HDD 45. Accordingly, the module type user ID and received reference data are stored and registered as the module type 301 user ID 302 and reference data 303 (Step S19). The system then proceeds to Step S14.

If there is no same module type 402 (NO in Step S15) or the received data is error data (YES in Step S18), the reference data search error data is sent to the MFP 2A through the communication section 46 and communication network N (Step S20). The first reference data providing process then terminates.

Referring to FIGS. 7 and 8, the following describes the second reference data providing process to be implemented by the MFP 2B, in response to the first reference data providing process. For example, immediately when the second reference data providing process execution instruction is inputted from the communication section 18 in the MFP 2B, the second reference data providing program is read from the HDD 15 and is displayed on the RAM 13. The second reference data providing process is performed through collaboration between the CPU 11 and the second reference data providing process displayed on the RAM 13.

A decision step is taken to determine whether or not the user ID has been received from the server 40 through the communication section 18, in response to Step S16 (Step S31). If the user ID has not been received (NO in Step S31), the system goes to Step S31. If the user ID has been received (YES in Step S31), the reference data corresponding to the received user ID is searched from the first reference database DB 200 stored in the memory 35 (Step S32). A decision step is taken to determine if the reference data corresponding to the user ID is present or not (Step S33).

If the reference data corresponding to the user ID is present (YES in Step S33), the reference data corresponding to (the module type) and user ID is sent to the server 40 through the communication section 18 and communication network N (Step S34), in response to Step S17. Then the second reference data providing process terminates.

If the reference data corresponding to the user ID is not present (NO in Step S33), the reference data search error data is sent to the server 40 through the communication section 18 and communication network N, in response to Step S17 (Step S35). Then the second reference data providing process terminates.

The present embodiment provides person-verification without deteriorating the verification precision even in the presence of different types of fingerprint verification modules. A decision step is taken to determine the success or failure of user verification in the comparison between the data to be verified and the reference data of the first reference database. In the event of failure in user verification, a decision is made on the success or failure of the user verification. This arrangement of the present invention provides a person verification system comprising: an MFP characterized by improved maneuverability of person verification using a plurality of types of fingerprint verification modules; and a server compatible with a plurality of types of fingerprint verification modules, without the need of installing a server for each of the plurality of types of fingerprint verification modules.

The present embodiment is configured in such a way that, when an unregistered reference data has been received by the server 40, the received reference data is registered in the record of the reference database DB. However, the present invention is restricted thereto. For example, it is also possible to use a first arrangement wherein a plurality of MFPs stores the data separately in the server 40, without the reference database DB being stored. In this arrangement, when the server 40 has been required by a predetermined MFP to provide the reference data, the MFP having a corresponding module type is requested to search the reference data. When the data has been obtained, it is sent to the MFP having requested the same. This arrangement improves the security of the reference data. However, it fails to a request (to search) for reference data cannot be made to the MFP which is not working due to the power having been turned off or for some other reason, from the server 40. This may reduce processing performance.

It is also possible to use a second arrangement wherein the reference data contained in all the MFPs is uploaded onto the server 40 so that the server 40 stores all the reference data. This arrangement eliminates the need of considering a possible MFP failure, and the need of requesting the MFP to provide the reference data. This arrangement enhances the processing performance but may reduce the security of the reference data collectively stored in the server 40. The present embodiment uses the arrangement intermediate between the aforementioned first and second arrangements, and therefore enhances the processing performance while improving the security of the reference data.

It is also possible to make such arrangements that, when the permission to use the MFP has been granted, the user having been granted the permission can utilize the operation screen, destination address book, stamp, signature, confidential print and other functions designed for the particular use of that user.

### Embodiment 2

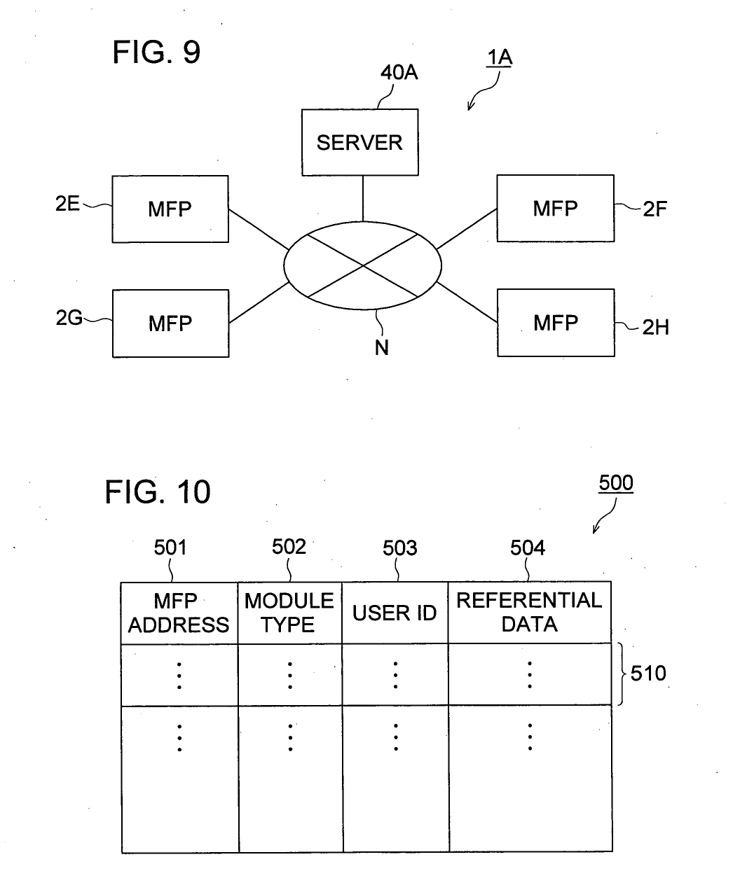

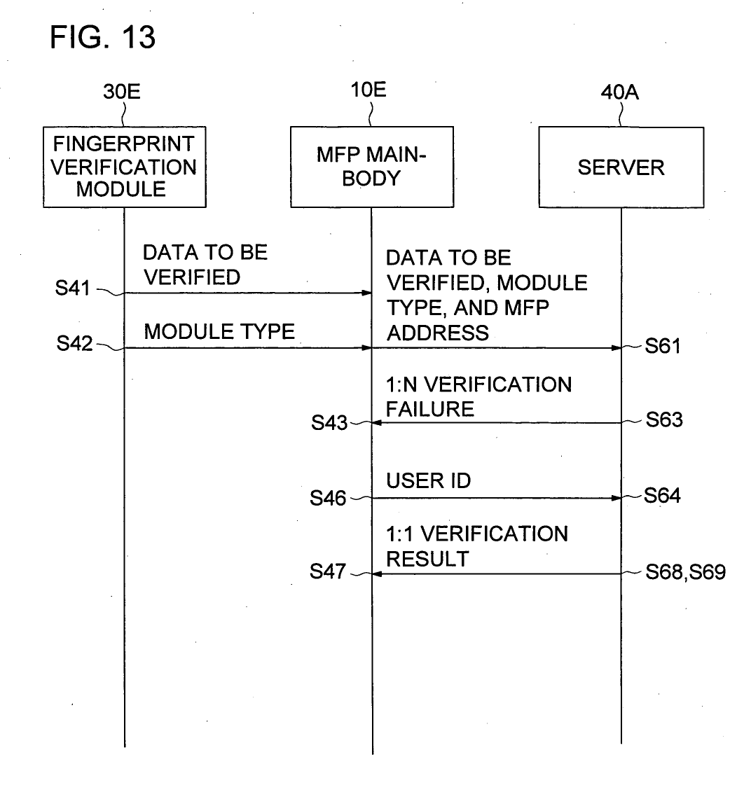

Referring to FIGS. 9 and 13, the following describes the second embodiment of the present invention. In the first place, the configuration of the apparatus of the present embodiment will be described with reference to FIG. 9. FIG. 9 shows the configuration of the MFP system 1A as the present embodiment. The configuration of the apparatus of the present embodiment is the same as that of the MFP system 1 as the first embodiment, and therefore, mainly the differences therefrom will be described below.

As shown in FIG. 9, the MFP system 1A as the person verification system of the present embodiment comprises the MFPs 2E, 2F, 2G and 2H as person verification apparatuses, and the server 40A as an information processing apparatus. These apparatuses are connected via the communication network N to permit mutual communication.

The MFP 2E comprises an MFP main body 10E and a fingerprint verification module 30E. The MFP main body 10E and fingerprint verification module 30E are the same as the MFP main body 10A of the MFP 2A and fingerprint verification module 30A of the first embodiment. The same reference numerals will be used in the following description. In the present embodiment, the HDD 15 of the MFP main body 10E stores the second person verification program for second person verification process to be described later. The memory 35 of the fingerprint verification module 30E a third storage section for storing the module type information 100. It does not store the first reference database DB 200. The same description applies to the MFP 2F, 2G and 2H.

In the MFPs 2E, 2F, 2G and 2H, each of the fingerprint verification modules provided has a fingerprint inputting and data to be verified extraction function, but does not have a verification function of data to be verified. Further, the number of the MFPs installed on the MFP system 1A and the combination thereof are not restricted to the example of FIG. 9.

The internal configuration of the server 40A is the same as that of the server 40 in the first embodiment, and therefore, the same reference numerals will be utilized in the following description. The HDD 45 of the server 40A is a fourth storage section for storing the third reference database DB 500 to be described later, and the verification result providing program for verification result providing process. It does not store the second reference database DB 300 or the module type information database DB 400.

Referring to FIG. 10, the following describes the data stored in the server 40A. FIG. 10 shows the configuration of the third reference database DB 500.

The HDD 45 stores the third reference database DB 500 shown in FIG. 10. The third reference database DB 500 contains such items as an MFP address 501 as the communication address of the MFPs 2E, 2F, 2G and 2H; a module type 502 corresponding to the MFP address 501; a user ID 503 corresponding to the module type; and reference data 504 corresponding to the stacking section 503.

In the present embodiment, the MFPs 2E and 2F have the same module type, and the 2G and 2H have the same module type. The third reference database DB 500 has a user record registered in advance. In the MFPs 2E, 2F, 2G and 2H, for example, a fingerprint is inputted by the user through the fingerprint input section 32 in each fingerprint verification module, and the image data thereof is obtained. In each MFP, the inputted user ID and the data to be verified are uploaded into the server 40A through the communication section 18 and communication network. In the server 40A, the received user ID, module type, MFP address and data to be verified are stored in the third reference database DB 500. Further, the reference data 504 of the third reference database DB 500 is encrypted before being stored.

The third reference database DB 500 contains a reference data group 510. The reference data group 510 has a 1:N verification record. For example, it has a plurality of records of users frequently utilizing the MFP. The number of records of the reference data group 510 can be either fixed or variable. The content (person) of each record of the reference data group 510 can be either fixed or variable. In the present embodiment, the content (person) of each record of the reference data group 510 is assumed as fixed for the sake of explanation. For example, an arrangement is made such that the data to be verified of an user frequently utilizing the MFP is registered as each record of the reference data group 510 and is updated by the input by an manager through the operation section 42 of the server 40.

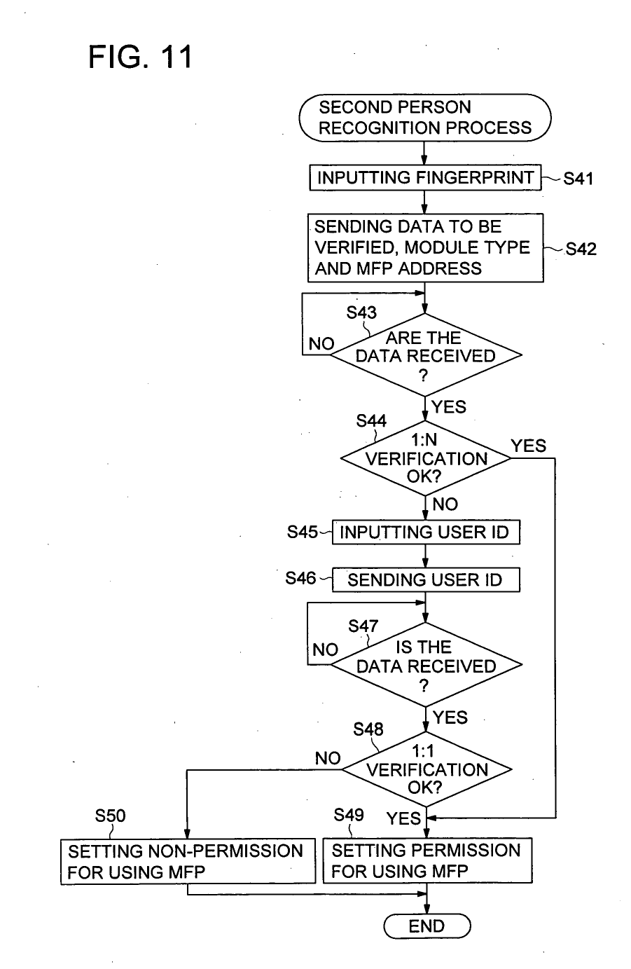

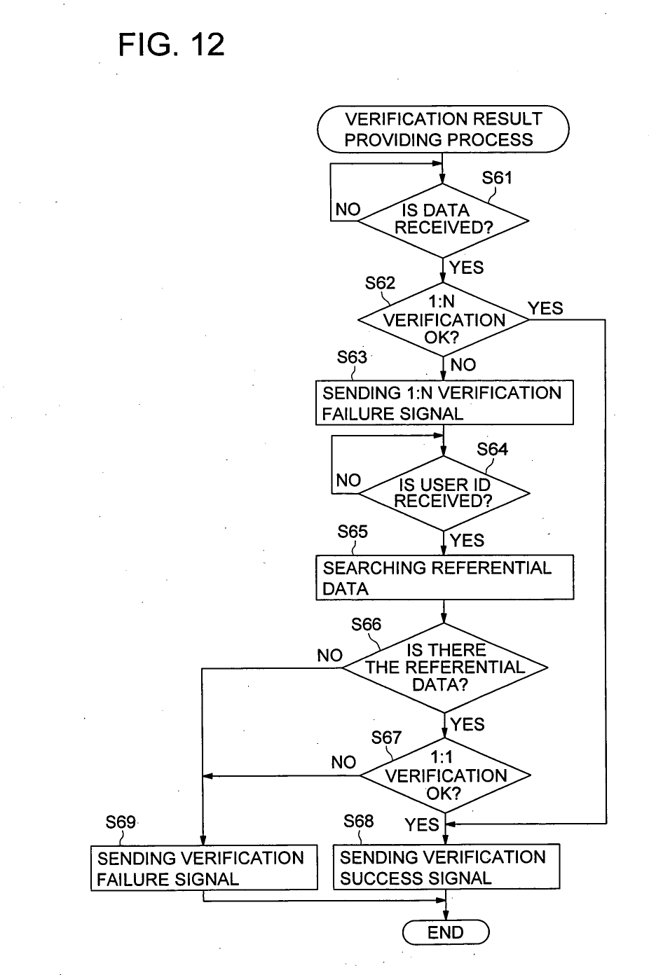

The following describes the operation of the MFP system 1A with reference to FIGS. 11 through 13. FIG. 11 shows the flow of the second person verification process. FIG. 12 shows the flow of the verification result providing process. FIG. 13 shows the flow of the second person verification process and others.

In the present invention, the following description uses a typical example wherein the second person verification process shown in FIG. 11 is executed by the MFP 2E. The description is also applicable to other MFPs. The verification result providing process shown in FIG. 12 is performed by the server 40A.

The following describes the second person verification process executed by the MFP 2E with reference to FIGS. 11 and 13. For example, immediately when the second person verification process execution instruction has been inputted from the operation section 12, the second person verification program is read from the HDD 15, and is displayed on the RAM 13. The second person verification process is performed through collaboration between the CPU 11 and the displayed second person verification program.

In the first place, in the fingerprint verification module 30E, a fingerprint is inputted by the user through the fingerprint input section 32, and the image data thereof is obtained. The data to be verified representing the features of the fingerprint is extracted from that image data (Step S41). The data to be verified obtained in Step S41 is sent to the MFP main body 10E from the fingerprint verification module 30E through the interface 34.

In the fingerprint verification module 30E, the module type 101 of the module type information 100 stored in the memory 35 is read out, and the module type thereof is sent to the MFP main body 10E from the fingerprint verification module 30E through the interface 34. In the MFP main body 10E, the module type, the data to be verified obtained in Step S41 and the MFP address of the apparatus are sent to the server 40A through the communication section 18 and communication network N (Step S42). The data sent in Step S42 includes the message representing the 1:N verification request of the data to be verified corresponding to the module type.

A decision step is taken to determine whether or not the 1:N verification result has been received through the communication network N and communication section 18 (Step S43). If the 1:N verification result has not been received (NO in Step S43), the system goes to the Step S43. If the 1:N verification result has been received (YES in Step S43), a decision is made on the success or failure of the received 1:N verification result (Step S44).

If the 1:N verification has failed (NO in Step S44), the user ID is inputted in the MFP main body 10E by the user having inputted the fingerprint through the operation section 12 (Step S45). The inputted user ID is sent to the server 40 through the communication section 18 and communication network N (Step S46). The data sent in Step S46 includes the 1:1 verification request message for the data to be verified corresponding to the module type and user ID.

A decision step is taken to determine whether or not the 1:1 verification result has been received from the server 40 through the communication section 18 (Step S47). If the 1:1 verification result has not been received (NO in Step S47), the system proceeds to Step S47. If the 1:1 verification result has been received (YES in Step S47), a decision is made on the success or failure of the received 1:1 verification result (Step S48).

When the 1:N verification has succeeded (YES in Step S44) or the 1:1 verification has succeeded (YES in Step S48), fingerprint verification has been successful. Thus, the permission to use the MFP 2E by the user having inputted the fingerprint is set in the MFP main body 10E (Step S49). Then the second person verification process terminates.

When the 1:1 verification has failed (NO in Step S48), the non-permission to use the MFP 2E by the user having been inputted the fingerprint is set (Step S50), and the second person verification process terminates.

Referring to FIGS. 12 and 13, the following describes the reference data providing process implemented by the server 40A, in response to the second person verification process. For example, immediately when the verification result providing process execution instruction has been inputted from the communication section 46, the verification result providing program is read from the HDD 45 and is displayed on the RAM 43. Verification result providing process is performed through collaboration between the CPU 41 and the verification result providing process displayed on the RAM 43.

A decision step is taken to determine whether or not the MFP address, module type and data to be verified have been received from the MFP 2E, in response to the Step S42 (Step S61). If the MFP address, module type and data to be verified have not been received (NO in Step S61), the system goes to Step S61. If the MFP address, module type and data to be verified have been received (YES in Step S61), comparison is made between the received data to be verified of the fingerprint and the reference data of the reference data group 510 of the third reference database DB 500. The success or failure of the 1:N verification is determined (Step S62), depending on whether or not matching is found in the reference data.

If the 1:N verification has failed (NO in Step S62), a 1:N verification failure message is sent to the MFP 2E of the MFP address received in Step S61, through the communication section 46 and communication network N (Step S63). A decision step is taken to determine whether or not the user ID has been received from the MFP 2E through the communication network N and communication section 46 (Step S64). If the user ID has not been received (NO in Step S64), the system goes to Step S64. If the user ID has been received (YES in Step S64), the reference data corresponding to the received module type and the user ID is searched in the third reference database DB 500 stored in the HDD 45.

A decision step is taken to determine whether or not there is the reference data corresponding to the module type and user ID (Step S66). If there is the reference data corresponding to the module type and user ID (YES in Step S66), the received data to be verified is compared with the searched reference data corresponding to the module type and user ID. The success or failure of the 1:1 verification is determined (Step S67), depending on whether or not matching is found in this comparison.

If the 1:N verification has succeeded (YES in Step S62) or 1:1 verification has succeeded (YES in Step S67), a 1:1 verification success message or a 1:N verification success message is sent to the MFP 2E through the communication section 46 and communication network N (Step S68). Then the person verification result providing process terminates.

If there is no reference data corresponding to the module type or user ID (NO in Step S66) or the 1:1 verification has failed (NO in Step S67), the 1:1 verification failure message is sent to the MFP 2E through the communication section 46 and communication network N (Step S69). Then the verification result providing process terminates.

The present embodiment provides a person verification system comprising: an MFP capable of ensuring person verification without deteriorating the verification precision even in the presence of different types of fingerprint verification modules; and a server characterized by improved maneuverability even in the presence of different types of fingerprint verification modules operated by a plurality of users.

### Embodiment 3

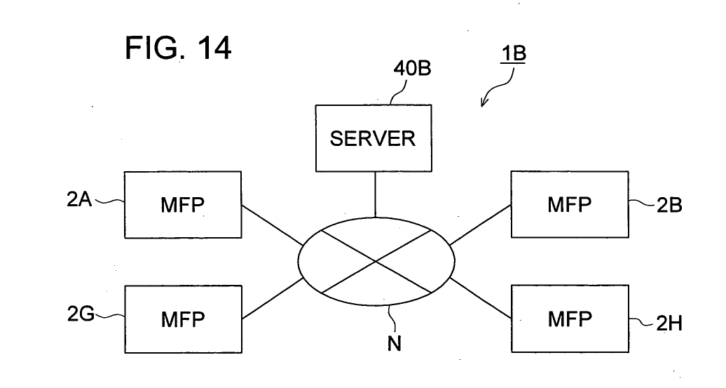

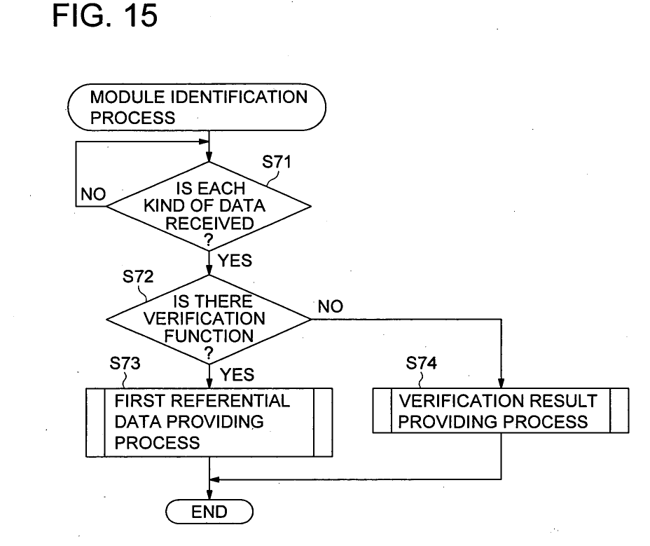

The following describes the third embodiment of the present invention with reference to FIGS. 14 and 15. The present embodiment is composed of a combination of the first and second embodiments.

Referring to FIG. 14, the configuration of the apparatus of the present embodiment will be described. FIG. 14 shows the configuration of the MFP system 1B. The configuration of the apparatus of the present embodiment is the same as that of the MFP system 1 of the first embodiment, and therefore, mainly the differences therefrom will be described below.

As shown in FIG. 14, the MFP system 1B as the person verification system of the present embodiment comprises the MFPs 2A and 2B as person verification apparatuses, the MFPs 2G and 2H, and the server 40B as an information processing apparatus. These apparatuses are connected via the communication network N to permit mutual communication.

The MFPs 2A and 2B described in the first embodiment have the same module type, and the fingerprint verification module provided has a verification function of data to be verified. The MFPs 2G and 2H explained in the description of the second embodiment have the same module type, but the fingerprint verification module provided has no verification function of data to be verified. The module type corresponding to the MFPs 2A and 2B includes the message indicative of the presence of a verification function of data to be verified. The module type corresponding to the MFPs 2A and 2B includes the message indicative of the absence of a verification function of data to be verified. Further, the number of the MFPs provided in the MFP system 1B and the combination thereof include the message indicative of the presence of a verification function of data to be verified, without limiting to the example of FIG. 14.

The internal configuration of the server 40B is the same as that of the server 40 described in the first embodiment, and therefore, the same reference numerals will be employed in the following description. The HDD 45 of the server 40B stores the third reference database DB 500, module type information database DB 400 and module identification program.

Referring to FIG. 15, the following describes the operation of the MFP system 1B. FIG. 15 shows the flow of the module identification process.

In the present embodiment, the module identification process shown in FIG. 15 is implemented by the server 40B. The first person verification process shown in FIG. 5 is implemented in the MFPs 2A and 2B, and the second person verification process shown in FIG. 11 is implemented in the MFPs 2G and 2H.

The following describes the module identification process implemented in the server 40B, with reference to FIG. 15. For example, immediately when module identification process execution instruction has been inputted from the communication section 46, module identification program is read from the HDD 45, and is displayed on the RAM 43. The module identification process is performed through collaboration between the CPU 41 and the module identification program displayed on the RAM 43.

A decision step is taken to determine whether or not various forms of data have been received from the MFP through the communication network N and communication section 46, in response to the first person verification process step S4 or second person verification process step S42 (Step S71). Such data never fails to include a module type. If such data has not been received (NO in Step S71), the system proceeds to the step S71. When data has been received (YES in Step S71), reference is made to the module type in the received data, and a decision is made to see whether or not the fingerprint verification module of the MFP as a sender has a verification function of data to be verified, based on the module type.

If there is a message indicative of the presence of the verification function (YES in Step S72), the fingerprint verification module of the MFP as a sender has a verification function of data to be verified. The first reference data providing process is performed, except for the Step S11 shown in FIG. 6 (Step S73), and module identification process then terminates.

If there is no message indicative of the presence of the verification function (NO in Step S72), the fingerprint verification module of the MFP as a sender has no verification function of data to be verified. The verification result providing process except for the Step S61 shown in FIG. 12 is performed (Step S74), and module identification process then terminates. In Step S74, the third reference database DB 500 is used instead of the second reference database DB 300.

The present embodiment provides a person verification system a server compatible with both types of MFPs with and without a person verification function.

The description in the aforementioned embodiments indicate only some of the examples of the preferred person verification apparatus, information processing apparatus and person verification system of the present invention, without the prevent invention being restricted thereto.

It is possible to modify the details of the configurations and operations of the components constituting the person verification apparatus, information processing apparatus and person verification system of the aforementioned embodiments, without departing from the technological spirit and scope of the invention claimed. For example, two or more of the aforementioned embodiments and variations can be combined appropriately.

In the aforementioned embodiments, an arrangement of registering one piece of reference data for one person has been described. Without being restricted thereto, for example, it is also possible to arrange such a configuration that a plurality of pieces of reference data is registered for one person, wherein, in the 1:N verification, the data to be verified of the inputted fingerprint is compared with N (persons)×number of pieces of reference data, and in the 1:1 verification, the data to be verified of the inputted fingerprint is compared with a plurality of pieces of reference data corresponding to the user ID. In this case, for example, comparison can be made with the reference data most similar to the data to be verified, out of a plurality of pieces of reference data. Further, the aforementioned plural pieces of reference data for one person can be the plural pieces of reference data corresponding to plural fingers.

In the description of the aforementioned embodiments, reference has been made to the example of using the fingerprint information as the biological information for user verification. Without the prevent invention being restricted thereto, at least one of the iris, face, vein, and voice print can be used as biological information, for example.

1. A person verification apparatus, comprising:
a biological information input section to receive an input of biological information of a user and obtain data to be verified; and
a first control section to obtain previously registered reference data corresponding to information to identify a type of the biological information input section, and to perform a first person verification process for determining success or failure of a user verification by comparing the obtained reference data with the data to be verified.

2. The person verification apparatus of claim 1, further comprising:
a first memory section to store the information to identify a type of the biological information input section; and
an operation section to receive an input of a user ID, wherein the first control section obtains the information to identify a type of the biological information input section stored in the first memory section, and a previously registered reference data corresponding to the user ID inputted through the operation section, and performs the first person verification process for determining success or failure of the user verification by comparing the obtained reference data corresponding to the user ID with the data to be verified.

3. The person verification apparatus of claim 2, wherein the first memory section stores a first reference data group including plural user IDs and plural pieces of reference data which respectively correspond to the plural user IDs, and the first control section determines success or failure of the user verification by comparing the data to be verified with each of the plural pieces of reference data, and when the user verification has failed, the first control section obtains a piece of previously registered reference data corresponding to the user ID inputted through the operation section, and performs the first person verification process for determining success or failure of the user verification by comparing the obtained piece of reference data corresponding to the user ID with the data to be verified.

4. An information processing apparatus connected to be capable of mutual communication with a person verification apparatus having a biological information input section to receive an input of biological information of a user and obtain data to be verified, the information processing apparatus comprising:
a second control section that performs, when information to identify a type of the biological information input section is inputted from the person verification apparatus, a first reference data providing process for searching a piece of reference data corresponding to the information to identify a type of the biological information input section, and for outputting a result of the searching.

5. The information processing apparatus of claim 4, wherein when a user ID and the information to identify a type of the biological information input section are inputted from the person verification apparatus, the second control section performs the first reference data providing process for searching a piece of reference data corresponding to the user ID and to the information to identify a type of the biological information input section, and for outputting a result of the searching.

6. The information processing apparatus of claim 5, further comprising a second memory section for storing a verification apparatus type data group, in which identifying information of the person verification apparatus to perform a user verification process is correlated with information to identify a type of the biological information input section provided to the person verification apparatus,
wherein when a user ID and the information to identify a type of the biological information input section are inputted from the person verification apparatus, the second control section searches a person verification apparatus corresponding to the information to identify a type of the biological information input section from the verification apparatus type data group, and obtains the reference data from the person verification apparatus searched to output the reference data obtained.

7. The information processing apparatus of claim 6, wherein the second memory section stores a second reference data group, in which the information to identify a type of the biological information input section, a user ID, and previously registered reference data of a user are correlated with each other, and
when a user ID and information to identify a type of the biological information input section are inputted from the person verification apparatus, the second control section searches reference data corresponding to the inputted user ID and the inputted information to identify a type of the biological information input section, and
when the second control section has determined that there is no corresponding reference data in the second reference data group, the second control section searches a person verification apparatus corresponding to the information to identify a type of the biological information input section from the verification apparatus type data group, and obtains the corresponding reference data from the person verification apparatus searched to output the reference data.

8. A person verification apparatus, comprising:
a biological information input section to receive an input of biological information of a user and obtain data to be verified;
an operation section to receive an input of a user ID; and
a third control section to request a user verification by adding information to identify a type of the biological information input section and information to identify the person verification apparatus onto the obtained data to be verified, and to perform, when a result is inputted that the user verification has failed, a second person verification process for requesting user verification again by further adding the user ID inputted through the operation section.

9. An information processing apparatus connected to be capable of mutual communication with a person verification apparatus having a biological information input section to receive an input of biological information of a user and obtain data to be verified, the information processing apparatus comprising:
a fourth memory section to store a third reference data group in which information to identify the person verification apparatus, information to identify a type of the biological information input section, a user ID, and reference data of the biological information of the user are respectively correlated with each other; and
a fourth control section, wherein when the information to identify the person verification apparatus, the information to identify a type of the biological information input section, and the data to be verified, obtained through the biological information input section, are inputted from the person verification apparatus, the fourth control section determines success or failure of a user verification by comparing the data to be verified obtained by the biological information input section with each piece of reference data in the third reference data group, and
when the user verification has failed, the fourth control section receives a user ID, obtains reference data corresponding to the user ID from the third reference data group, and performs a verification result providing process to determine the success or failure of the user verification by comparing the obtained reference data corresponding to the user ID with the data to be verified obtained by the biological information input section and to output the verification result.

10. The person verification system comprising:
a person verification apparatus, comprising:
a biological information input section to receive an input of biological information of a user and obtain data to be verified; and
a first control section to obtain previously registered reference data corresponding to information to identify a type of the biological information input section and to perform a first person verification process for determining success or failure of a user verification by comparing the obtained reference data with the data to be verified, and
an information processing apparatus connected to be capable of mutual communication with the person verification apparatus, the information processing apparatus comprising:
a second control section, wherein when information to identify a type of the biological information input section is inputted from the person verification apparatus the second control section performs a first reference data providing process for searching a piece of reference data corresponding to the information to identify a type of the biological information input section, and for outputting a result of the searching.

11. The person verification system comprising:
a person verification apparatus, comprising:
a biological information input section to receive an input of biological information of a user and obtain data to be verified;
an operation section to receive an input of a user ID; and
a third control section to request a user verification by adding information to identify a type of the biological information input section and information to identify the person verification apparatus onto the obtained data to be verified, and to perform, when a result is inputted that the user verification has failed, a second person verification process for requesting user verification again by further adding the user ID inputted through the operation section, and
an information processing apparatus connected to be capable of mutual communication with the person verification apparatus, the information processing apparatus comprising:
a fourth memory section to store a third reference data group in which information to identify the person verification apparatus, information to identify a type of the biological information input section, a user ID, and reference data of the biological information of the user are respectively correlated with each other; and
a fourth control section, wherein when the information to identify the person verification apparatus, the information to identify a type of the biological information input section, and the data to be verified obtained through the biological information input section are inputted from the person verification apparatus, the fourth control section determines success or failure of a user verification by comparing the data to be verified obtained by the biological information input section with each piece of reference data in the third reference data group, and
when the user verification has failed, the fourth control section receives a user ID, obtains reference data corresponding to the user ID from the third reference data group, and performs a verification result providing process to determine the success or failure of the user verification by comparing the obtained reference data corresponding to the user ID with the data to be verified obtained by the biological information input section and to output the verification result.

12. A person verification system comprising:
a first person verification system including:
a first person verification apparatus, comprising:
a biological information input section to receive an input of biological information of a user and obtain data to be verified; and
a first control section to obtain previously registered reference data corresponding to information to identify a type of the biological information input section and to perform a first person verification process for determining success or failure of a user verification by comparing the obtained reference data with the data to be verified, and
an information processing apparatus connected to be capable of mutual communication with the person verification apparatus, the information processing apparatus comprising:
a second control section, wherein when information to identify a type of the biological information input section is inputted from the person verification apparatus the second control section performs a first reference data providing process for searching a piece of reference data corresponding to the information to identify a type of the biological information input section, and for outputting a result of the searching; and
a further person verification system of claim 11,
wherein the information processing apparatus of said first person verification system determines whether to perform the first reference data providing process to output the reference data onto the first person verification apparatus based on the information to identify a type of the biological information input section, or the information processing apparatus of said further person verification system determines whether to perform the verification result providing process to determine the success or failure of the user verification and to output the verification result.
